(19) United States
(12) Patent Application Publication
(10) Pub. No.: US 2012/0088028 A1
(43) Pub. Date: Apr. 12, 2012

(54) Process for Producing a Positive Nickel Hydroxide Electrode for a Nickel-Metal Hydride or Nickel Cadmium Storage Battery

(75) Inventors: Uwe Schaffrath, Korbach (DE); Detlef Ohms, Gottingen (DE); Gabor Benczúr-Urmössy, Stuttgart (DE); Rainer Markolf, Twistetal (DE); Katja Schmelter, Brilon (DE)

(73) Assignee: HOPPECKE BATTERIE SYSTEME GMBH, Brilon (DE)

(21) Appl. No.: 13/267,916

(22) Filed: Oct. 7, 2011

(30) Foreign Application Priority Data
Oct. 9, 2010 (DE) 10 2010 048 009.6

(51) Int. Cl. H01M 4/139

(52) U.S. Cl. 427/126.1

(57) ABSTRACT

In a process for producing a positive nickel hydroxide electrode for a nickel-metal hydride or nickel-cadmium storage battery a positive nickel hydroxide electrode produced in an earlier stage in the process is after-treated by introducing a saline solution into the active mass contained in an electrode carrier structure of the electrode in order to obtain a positive nickel hydroxide electrode with an improved current yield.

### BACKGROUND OF THE INVENTION

The invention relates to a process for producing a positive nickel hydroxide electrode for alkaline storage batteries, e.g. a nickel-metal hydride storage battery or a nickel-cadmium storage battery. Alkaline storage batteries, e.g. nickel-metal hydride storage batteries or nickel-cadmium storage batteries, are known to a person of skill in the art.

Nickel-metal hydride storage batteries and nickel-cadmium storage batteries have a positive electrode made from nickel hydroxide. The negative electrode is formed from a metal hydride. A lye, such as a caustic potash, is used as the electrolyte.

Nickel-metal hydride storage batteries have proved themselves in everyday practical applications. They provide roughly twice the energy density of nickel-cadmium storage batteries at the same voltage. In addition, they are more durable than nickel-cadmium storage batteries and work entirely without the noxious heavy metal cadmium.

The positive nickel hydroxide electrode of a nickel-metal hydride storage battery has an electrode carrier structure as the carrier material. This may be formed from a nickel-plated non-woven material, for example. The electrode carrier structure contains the electrode's active mass. This may be provided in the form of a paste, for example, and be introduced into the electrode carrier structure by vibration filling. The active mass contains nickel hydroxide as the main component. To improve conductivity in particular, conductive additives such as graphite, carbon and/or also metal powder may be added to the nickel hydroxide.

The above configuration described of a positive nickel hydroxide electrode in a nickel-metal hydride storage battery or a nickel-cadmium storage battery is known from the state of the art, as well as the process used for its production.

U.S. Pat. No. 6,221,529 additionally discloses a process in which a nickel hydroxide electrode is converted by electrolysis into a positive nickel oxyhydroxide electrode for use in a lithium battery. For this purpose, the nickel hydroxide electrode is immersed in an electrolyte formed from a saline solution.

US 2006/0166099 A1 relates to the production of a positive nickel hydroxide electrode with an electrode carrier structure for use in a nickel-metal hydride storage battery. During final assembly, the nickel hydroxide electrodes that have been finally designed are introduced into the storage battery housing along with the electrolyte. The electrolyte may be in the form of a saline solution.

Although positive nickel hydroxide electrodes known in the prior art have proved themselves of value, there is a need for improvement, particularly with regard to an improved current yield. The problem addressed by the invention is therefore to propose an improved positive nickel hydroxide electrode for a nickel-metal hydride storage battery or nickel cadmium storage battery that is an improvement related to the state of the art, particularly to the extent that an improved current yield is achieved.

### SUMMARY OF THE INVENTION

To solve this problem, the invention proposes a process for producing a positive nickel hydroxide electrode for an alkaline nickel-cadmium or nickel-metal hydride storage battery, in which a positive nickel hydroxide electrode produced in an earlier stage in the process is after-treated by introducing a saline solution into the active mass contained in an electrode carrier structure of the electrode.

The starting point for conducting the process according to the invention is a positive nickel hydroxide electrode produced in a known fashion according to the state of the art. This is after-treated in a manner according to the invention, whereby a saline solution is introduced into the active mass of the electrode as part of this after-treatment. The result of conducting this process is a positive nickel hydroxide electrode, the active mass of which has a saline solution introduced into it.

As a result of the implementation of the process, the electrode is coated with an activating substance in the form of a saline solution. This advantageously results in the formation of semi- and electrically conductive surface layers, through which the charge acceptance is improved and any unwanted swelling and/or ageing processes can be suppressed. The result of this is that an improved current yield can be achieved. The point of the invention, therefore, is not the use of saline solution in the production of active mass, but rather genuine after-treatment. “After-treatment” insofar as the starting point for implementation of the process according to the invention is a positive nickel hydroxide electrode produced in a known manner according to the state of the art. The point of the invention is to subject this kind of positive nickel hydroxide electrode produced in an earlier process stage and basically ready for use to additional treatment, which follows the earlier production stage. A positive nickel hydroxide electrode that is basically ready for use is therefore treated subsequently, namely, such that a saline solution is introduced into the active mass contained in the electrode carrier structure of the electrode. The electrode's active mass therefore has a saline solution added to it, subsequently.

Unlike the aforementioned state of the art according to U.S. Pat. No. 6,221,529 B1 and US 2006/0166099 A1, the point of the design according to the invention is not the use of an electrolyte either, which is in the form of a saline solution or contains a saline solution as a component. The electrodes produced using the process according to the invention are after-treated, namely insofar as a saline solution is introduced into the active mass of the electrodes. The electrodes designed in this way are then inserted into a storage battery housing in which electrolyte for the final storage battery design must also be introduced in a manner known by the art.

A metal salt solution is preferably used as the saline solution. In this case, the saline solution is selected such that the anions contained therein do not have a detrimental effect on the later cell reaction.

The implementation of the process according to the invention is used in principle to introduce different types of doping into the electrode's active mass subsequently through the saline solution used, namely into the electrode surface. These include, in particular, metal ions of subgroup elements such as zinc, manganese, iron, cobalt, niobium, cadmium, copper, yttrium, lanthanide or also main group elements, such as aluminium, barium and beryllium.

Penetration of the saline solution takes place according to a preferred embodiment of the invention by vacuum impregnation, wherein the saline solution is absorbed by the active mass. In accordance with this procedure, the electrode produced in an earlier production process is subjected to vacuum. As a result of this, the saline solution is absorbed by the active mass, wherein the saline solution has corresponding ions and can also be referred to as an activating substance to this extent. It is preferable in this case that the surface alkalinity of the electrode provides for a precipitation of the desired substances from the neutral or weakly acid saline solution, preferably a metal salt solution. The particular advantage of using a vacuum, in other words, vacuum impregnation, lies in a very rapid and uniform introduction of the saline solution into the electrode, and consequently into its active mass.

A pressure of 0.001 bar to 0.2 bar, preferably 0.01 bar to 0.15 bar, even more preferably 0.1 bar, is used as the pressure during vacuum impregnation. The length of time that the electrode is retained in the vacuum is between 10 seconds and 5 minutes, more preferably 60 seconds to 4 minutes, even more preferably from 2 to 3 minutes.

It goes without saying that the mentioned parameters related to pressure and retention period must be selected correspondingly depending on both the composition of the active mass and also the composition of the saline solution.

Once the saline solution has been introduced into the active mass, the electrode is removed from the activation solution, in other words the saline solution, and subsequently dried. The drying may be carried out in a circulating air oven provided for this purpose.

A further feature of the invention provides that repeated impregnation may be carried out with subsequent drying. Different activation solutions, in other words saline solutions, may be used for this in each case.

### BRIEF DESCRIPTION OF THE DRAWING

Further features and advantages of the invention emerge from the following description and the drawing.

FIG. 1 shows the implementation of the process according to the invention in diagrammatic form.

### DESCRIPTION OF PREFERRED EMBODIMENTS

The starting point for implementing the process according to the invention is, in accordance with the first process stage 1, the production of a positive nickel hydroxide electrode according to the state of the art. This electrode produced according to the state of the art undergoes after-treatment 2 according to the invention.

As part of the after-treatment 2, an activation solution is first introduced into the active mass of the electrode. In this case, the introduction of the activation solution into the active mass preferably takes place in a vacuum by vacuum impregnation 3. For this purpose, the electrode is introduced into a vacuum. As a consequence of this, the activation solution is automatically absorbed into the electrode's active mass and it penetrates the gaps between the active material particles of the active mass and also the pores of the electrode. The active mass is thereby provided with activating substances that originate from the activation solution.

In particular a saline solution, preferably a metal salt solution, can be used as the activation solution. In this case, ions of the metal salt solution constitute the activating substances.

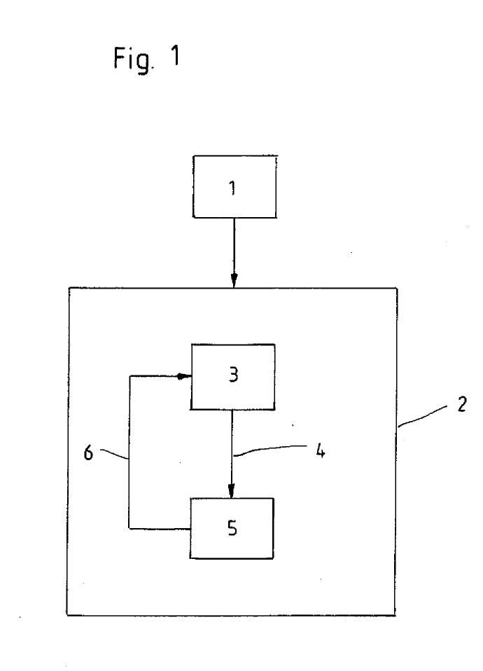

Following the vacuum impregnation 3, which is depicted by the arrow 4 in FIG. 1, drying 5 of the electrodes is provided. In accordance with the arrow 6, the vacuum impregnation 3 and subsequent drying 5 of the electrodes may be carried out repeatedly. In care of a metal salt solution as the activation solution, such solutions are preferably used with metal ions chemically precipitable at the neutral point, which have a pH value of between 2 and 9. Subgroup elements, in particular, such as zinc, manganese, iron, cobalt, niobium, cadmium, copper, yttrium and/or lanthanide are used as cations of the activation solution. However, main group elements may also be used, such as aluminium, barium and beryllium, or mixtures of the aforementioned ions, respectively.

The anions of the activation solution are preferably redox-stable such as e.g. borates, sulphates, perchlorates, phosphates, metaphosphates and/or silicates.

The application incorporates by reference the entire disclosure of German patent application DE 10 2010 048 009.6 having a filing date of 9 Oct. 2010 of which application priority is claimed for the instant application for patent.

While specific embodiments of the invention have been shown and described in detail to illustrate the inventive principles, it will be understood that the invention may be embodied otherwise without departing from such principles.

### LIST OF REFERENCE NUMERALS

1 Production of a positive nickel hydroxide electrode in accordance with the state of the art
2 After-treatment
3 Vacuum impregnation
4 Arrow
5 Drying
6 Arrow

What is claimed is:

1. A process for producing a positive nickel hydroxide electrode for a nickel-cadmium or nickel-metal hydride storage battery, the process comprising:
introducing a saline solution into an active mass contained in an electrode carrier structure of a positive nickel hydroxide electrode to after-treat the positive nickel hydroxide electrode.

2. The process according to claim 1, wherein the step of introducing comprises impregnating the positive nickel hydroxide electrode with the saline solution under vacuum, wherein the saline solution is absorbed by the active mass.

3. The process according to claim 2, comprising drying the positive nickel hydroxide electrode after the step of introducing.

4. The process according to claim 3, wherein impregnating under vacuum and drying are carried out repeatedly.

5. The process according to claim 2, wherein impregnating under vacuum is carried out at a pressure of 0.001 bar to 0.2 bar.

6. The process according to claim 2, wherein impregnating under vacuum is carried out for 10 seconds to 5 minutes.

7. The process according to claim 2, wherein the saline solution is a metal salt solution.

8. The process according to claim 1, comprising drying the positive nickel hydroxide electrode after the step of introducing.

9. The process according to claim 1, wherein the saline solution is a metal salt solution.
